(19) United States
(12) Patent Application Publication
(10) Pub. No.: US 2012/0269550 A1
(43) Pub. Date: Oct. 25, 2012

(54) Charging Device and Photosensitive Drum Component

(75) Inventors: Huajin Qin, Zhuhai (CN); Honghui Zhou, Zhuhai (CN)

(73) Assignee: Print-Rite Unicorn Image Products Co., Ltd., Zhuhai, Guangdong (CN)

(21) Appl. No.: 13/517,466

(22) PCT Filed: Dec. 7, 2010
(86) PCT No.: PCT/CN10/79487

§ 371 Date: Jun. 20, 2012

(30) Foreign Application Priority Data
Dec. 24, 2009 (CN) 200920295719.7

(51) Int. Cl. G03G 15/02

(52) U.S. Cl. 399/171

(57) ABSTRACT

A charging device having a corona grid and a fur brush. The corona grid has a side wall and a lower wall adjacent to the side wall. The lower wall is provided with a plurality of grids. A corona wire is provided above the lower wall of the corona grid, wherein a decompression module is provided between the corona grid and said fur brush. One end of the decompression module is connected with the corona grid and the other end is connected with the fur brush. A photosensitive drum component is also disclosed.

### FIELD OF THE INVENTION

The present invention relates to a charging device charging a photosensitive drum of a photosensitive drum component and the photosensitive drum component applying the charging device. The present invention is based on Chinese Utility Model Patent Application Number 200920295719.7, filed on Dec. 24, 2009. The entire content of the application is incorporated herein as a closely related reference to the present invention.

### BACKGROUND ART

A laser printer is a common printing device and provides great convenience for the modern office. An existing laser printer is mostly using a process cartridge detachably installed inside the laser printer to provide toner used for printing. In the printing process, the toner loaded in the process cartridge is transferred to a paper as a printing medium to form the desired pattern and text.

One existing process cartridge comprises a toner cartridge and a photosensitive drum component. The toner cartridge has a capacity of containing toner and provides a developer roller and other components. The toner cartridge can be detachably installed inside the photosensitive drum component and form a process cartridge along with the photosensitive drum component together.

Referring to FIG. 1, one existing photosensitive drum component comprises a lower frame 2. An upper frame 1 is installed on the lower frame 2. An opening of the upper part of the lower frame 2 is used for detachably installing a toner cartridge. A photosensitive drum 4 and a transfer roller 3 are also installed in the lower frame 2. The photosensitive drum 4 can receive toner sent out from the toner cartridge and transfer the toner on a paper. As shown in FIG. 2, a charging device is installed inside the upper frame 1. An end cap 12 is provided at one end of the upper frame 1. That is, a charging device comprising a corona wire 13, a corona grid 14 and a fur brush 20 is installed inside the upper frame 1. The corona grid 14 is set on the surface of the photosensitive drum 4 and has a first side wall 15 and a second side wall 16 relative to the first side wall. A lower wall 17 is provided between the first side wall 15 and the second side wall 16. The lower wall 17 is adjacent to the first side wall 15 and the second side wall 16. A plurality of grids like long strips is open on the lower wall 17 (not shown in FIG. 2).

The corona wire 13 is installed above the lower wall 17 of the corona grid 14. That is, the corona wire 13 is surrounded by the lower wall 17 of the corona grid 14, the first side wall 15 and the second side wall 16. When the process cartridge is working, the corona wire 13 is loaded with high-voltage electricity, typically 3000 volts DC. A high-voltage corona is formed. The high-voltage electricity is evenly loaded on the photosensitive drum 4 through grids 18 of the corona grid 14 and makes the surface of the photosensitive drum 4 to be charged evenly so that the photosensitive drum 4 can be easily exposed.

The fur brush 20 comprises a fur brush frame 21 and bristles 22 fixed on the fur brush frame 21. The bristles 22 contact with the surface of the photosensitive drum 4 and are used to clean the residual toner on the surface of the photosensitive drum 4 after the photosensitive drum 4 is exposed and transferred. An electrical contact 23 is provided at one end of the fur brush frame 21 and is used for connecting the laser printer for direct current. The voltage of the direct current is much lower than the voltage of the corona wire 13 and the corona grid 14, typically 450 volts DC charged on the bristles 22. When cleaning the toner, the charged bristles 22 adsorb the toner having opposite charge polarity in order to better clean the toner from the surface of the photosensitive drum 4.

However, due to different toner and transfer efficiencies of the photosensitive drum 4 and the transfer roller, especially different electricity of charged toner, the fur brush 20 loaded with the same voltages have different adsorbing capabilities on different charged toner. For some types of toner, the fur brush 20 loaded with 450 volts DC can adsorb toner better. But other types of toner cannot be easily adsorbed by the fur brush 20 loaded with 450 volts DC. With the printing operation, more toner is accumulated on the bristles 22. The residual toner is easily fallen off from the bristles 22 and contaminates the printing paper thus reducing the print quality.

### SUMMARY OF THE INVENTION

The primary object of the present invention is to provide a charging device loaded on a fur brush with adjustable voltages.

Another object of the present invention is to provide a photosensitive drum component capable of preventing toner to be fallen off from the fur brush.

In order to achieve the above objects, a charging device provided in the present invention comprises a corona grid and a fur brush. The corona grid has a side wall and a lower wall adjacent to the side wall. A plurality of grids is provided on the lower wall. A corona wire is provided above the lower wall of the corona grid, wherein a decompression module is provided between the corona grid and said fur brush. One end of the decompression module is connected with the corona grid and the other end is connected with the fur brush.

It can be seen from the above plan that the fur brush is electrically connected with the corona grid through the decompression module. That is, the fur brush gets the direct current from the corona grid but does not directly get the electricity from a laser printer. Thus, a manufacturer of process cartridge can calculate the right voltage loaded on the fur brush according to the electricity charged on the toner in the process cartridge. The voltage loaded on the fur brush can be realized by decompression through the decompression module.

It can be seen that the voltage loaded on the fur brush is not the fixed voltage provided by the laser printer but adjustable according to the toner's types to improve the adsorption capability of the bristles on toner.

One preferable plan is that the decompression module has a conductive film and a decompression device connected to the conductive film in series. The conductive film is connected with the corona grid and the decompression device is connected with the fur brush. Thus, the connection between the conductive film that is connected with the decompression device in series and the corona grid will help the depression module to be firmly connected with the corona grid and make the fur brush to get steady direct current.

Further plan is that a protrusion protruding outward is provided on a first side wall of the conductive film. A through-hole corresponding to the protrusion is provided at the side wall of the corona grid. It can be seen that the conductive film can be better connected with the corona grid through the correspondence of the protrusion of the conductive film to the through-hole of the corona grid in order to avoid the relative slide occurred between the conductive film and the corona grid, which results in bad contact and affects power supply from the corona grid to the fur brush.

To achieve another above object, the present invention provides a photosensitive drum component comprising a lower frame in which a photosensitive drum is installed, an upper frame installed on the lower frame and a charging device installed inside the upper frame. The charging device comprises a corona grid and a fur brush. The corona grid has a side wall and a lower wall adjacent to the side wall. A plurality of grids is provided on the lower wall. A corona wire is provided above the lower wall of the corona grid, wherein a decompression module is provided between the corona grid and the fur brush. One end of the decompression module is connected with the corona grid and the other end is connected with said fur brush.

Because the voltage of the corona grid is much higher than the voltage of the fur brush, right DC voltage can be formed on the fur brush through the decompression module set between the corona grid and the fur brush. Right decompression values for the decompression module can be calculated according to different adsorption properties of toner, thus optimizing the adsorption capability of the fur brush, avoiding the residual toner to be fallen off from the bristles and affecting the print quality.

### BRIEF DESCRIPTION OF THE DRAWINGS

FIG. 1 is an exploded perspective view illustrating a photosensitive drum component.

FIG. 2 is an enlarged exploded perspective view illustrating an existing charging device installed inside an upper frame.

FIG. 3 is an exploded perspective view illustrating an embodiment of a charging device installed inside an upper frame in the present invention.

FIG. 4 is a partially enlarged schematic view of a corona grid, a fur brush and a decompression module in the embodiment of the charging device in the present invention.

FIG. 5 is a partially enlarged schematic view of the corona grid and a conductive film in the embodiment of the charging device from another view in the present invention.

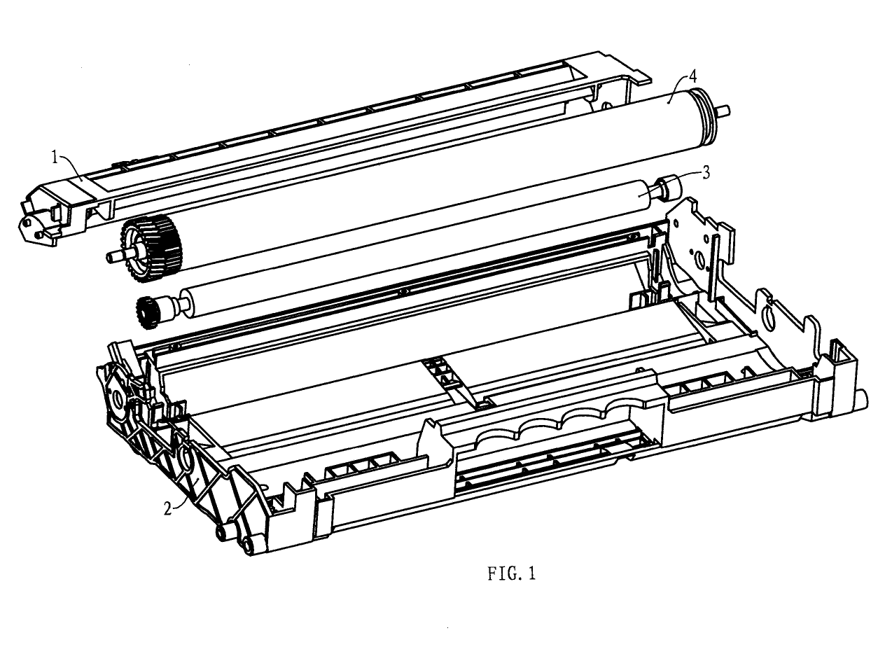

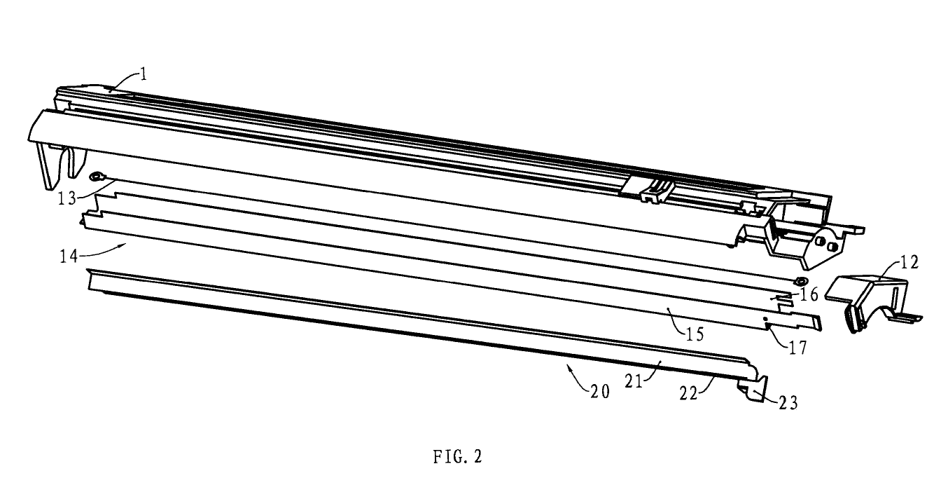

### DETAILED DESCRIPTION OF THE PRESENTLY PREFERRED EMBODIMENTS

A photosensitive drum component according to the present invention comprises a lower frame installing a photosensitive drum and a transfer roller and an upper frame installed on the lower frame. A charging device provided in the following embodiments according to the present invention is installed inside the upper frame. The upper part of the lower frame has an opening used for detachably installing a toner cartridge. The photosensitive drum component can be formed a process cartridge with the toner cartridge.

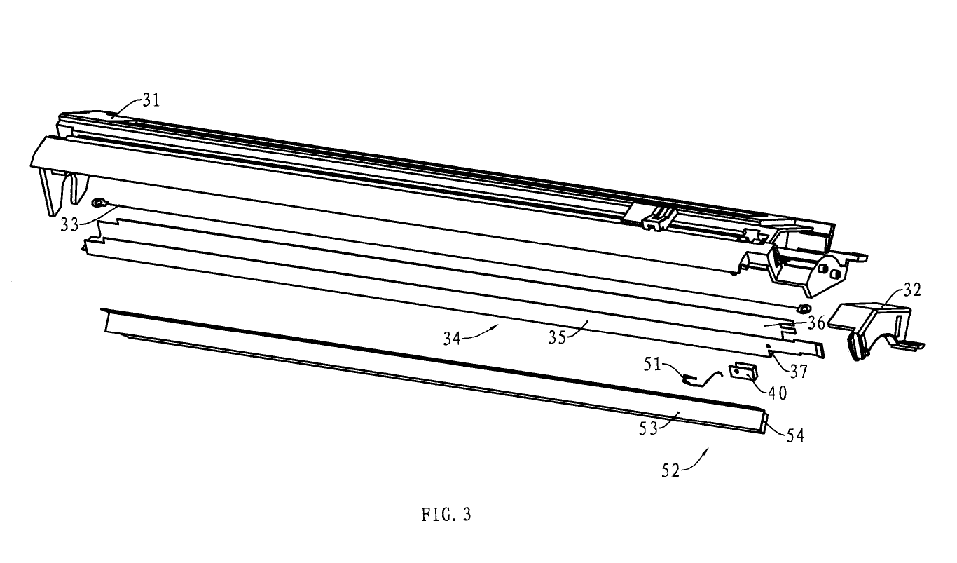

One embodiment of a charging device in the present invention is shown in FIG. 3. The charging device is installed inside a cap end 32 on an upper frame 31 of a photosensitive drum component and located at one end of the upper frame 31. The charging device comprises a corona grid 34 and a corona wire 33. The corona grid 34 has a first side wall 35 and a second side wall 36 relative to the first side wall 35. A lower wall 37 is provided between the first side wall 35 and the second side wall 36, and connected with the two side walls. The corona wire 33 is located above the lower wall 37.

A fur brush 52 is provided under the corona grid 34. The fur brush 52 comprises a fur brush frame 53 and bristles 54. A decompression module is provided between the corona grid 34 and the fur brush frame 53. In the embodiment, a decompression module comprises a conductive film 40 and a resistor 51 used as a decompression device in the embodiment, wherein the conductive film 40 is connected with the resistor 51 in series.

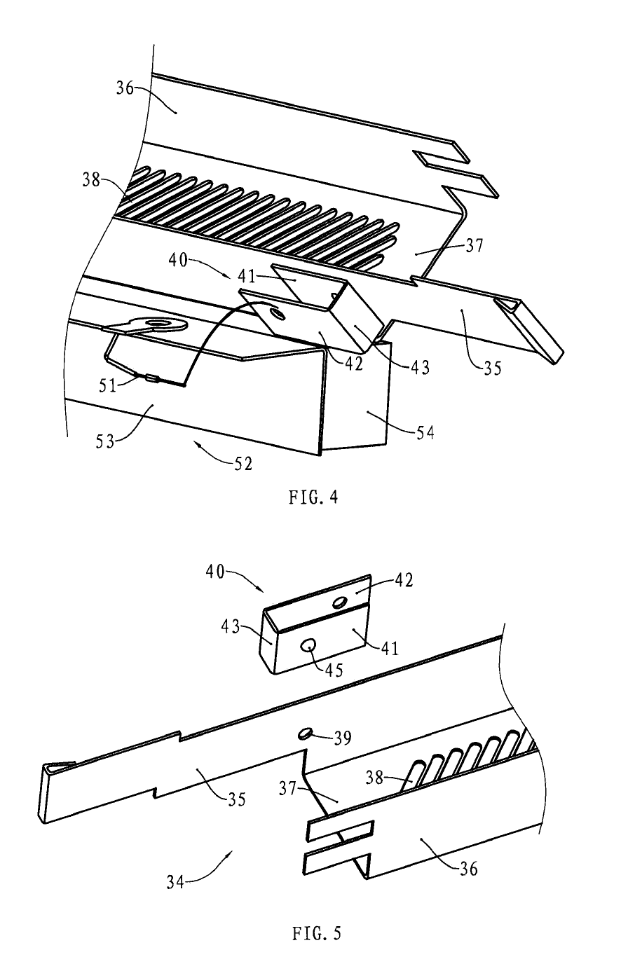

Referring to FIGS. 4 and 5, the conductive film 40 has a first side wall 41 and a second side wall 42 relative to the first side wall 41. A connection wall 43 is provided between the first side wall 41 and the second side wall 42. The first side wall 41 of the conductive film 40 is docked to the first side wall 35 of the corona grid 34. A through-hole 39 is provided on the first side wall 35 of the corona grid 34. A protrusion 45 is provided on the first side wall 41 of the conductive film 40. The protrusion 45 can be set into the though-hole 39 to achieve electrical connection between the conductive film 40 and the corona grid 34. A plurality of grids 38 like strips is provided on the lower wall 37 of the corona grid 34.

In the embodiment, the protrusion 45 looks like a coronary and the bottom diameter of the protrusion 45 is identical to the diameter of the through-hole 39. That is, the cross section of the protrusion 45 has the same shape as the through-hole 39, thus preventing slide of the first side wall 41 relative to the first side wall 35.

Of course, in practical application, a protrusion protruding outward can be provided on the first side wall 35 of the corona grid 34. Opening a through-hole corresponding to the protrusion on the first side wall 41 of the conductive film 40 can achieve the same effect.

One end of a resistor 51 is connected with the second side wall 42 of the conductive film 40 and the other end is connected to the fur brush frame 53 of the fur brush 52. When the photosensitive drum component is working, the laser printer provides high voltage DC to the corona grid 34. The DC flowing through the first side wall 35 of the corona grid 34 is conducted to the fur brush frame 53 of the fur brush 52 through the conductive film 40 and the resistor 51, thus the fur brush frame 53 is charged. Because the voltage loaded on the corona grid 34 is much higher than the voltage needed from the fur brush frame 53, the calculation is needed to select a right resistance of the resistor 51 for decompression, thus making a right voltage for the fur brush frame 53.

This shows that the voltage loaded on the fur brush frame 53 is obtained through decompression from the corona grid 34. Therefore, the resistor 51 with right resistance can be selected to adjust the voltage loaded on the fur brush frame 53 in order to adjust the voltage of the bristles 54. So, the voltage loaded on the fur brush frame 53 can be calculated according to the characteristics of toner in the process cartridge and the resistance of the resistor 51 can be calculated according to the loaded voltage.

The voltages loaded on the fur brush 52 can be different by selecting different resistances of the resistor 51 to adapt the toner with different characteristics. The residual toner on the photosensitive drum can be effectively adsorbed by the fur brush 52 to avoid the paper to be contaminated by the residual toner and to ensure print quality.

Of course, in practical application, a specific decompression circuit can be replaced the resistor as a decompression device. Preferably, selecting the decompression circuit adjustable for resistance is easier for making a process cartridge.

Finally, it should be emphasized that the present invention is not limited to the above embodiments. Minor changes such as shape changes of the protrusion and the through-hole and the set position changes between the protrusion and the through-hole should also be included within the protection scope of the claimed invention.

### INDUSTRIAL APPLICABILITY

In the present invention, a fur brush is connected with a corona grid through a decompression module. That is, the fur brush gets direct current from the corona grid not directly from the laser printer. So, a manufacturer of a process cartridge can calculate a right voltage loaded on the fur brush according to the electricity charged on the toner in the process cartridge and achieve the right voltage loaded on the fur brush through the decompression module. Because the voltage of the corona grid is much higher than the voltage of the fur brush, the decompression through the decompression module set between the corona grid and the fur brush can form a right DC voltage on the fur brush. A right decompression value can be calculated according to the adsorption characteristics of different toner, thus optimizing the adsorption capabilities of the fur brush and preventing the residual toner to be fallen off from the bristles to affect the print quality.

1-10. (canceled)

11. A charging device comprising:
a corona grid and a fur brush, wherein said corona grid has a side wall and a lower wall adjacent to said side wall, said lower wall is provided with a plurality of grids, and a corona wire located above the lower wall of said corona grid,
wherein, a decompression module is provided between said corona grid and said fur brush, one end of said decompression module being connected with said corona grid, and the other end of said decompression module being connected with said fur brush.

12. The charging device according to claim 11, wherein said decompression module has a conductive film and a decompression device connected with said conductive film in series.

13. The charging device according to claim 12, wherein said decompression device is one of a resistor and a decompression circuit.

14. The charging device according to claim 12, the first side wall of said conductive film is provided with a protrusion protruding outward, and the side wall of said corona grid is provided with a through-hole corresponding to said protrusion.

15. The charging device according to claim 12, wherein said conductive film has a first side wall being docked to the side wall of said corona grid and a second side wall being connected with said first side wall through a connection wall, wherein said second side wall is connected with said fur brush through said decompression device.

16. The charging device according to claim 15, wherein said decompression device comprises one of a resistor and a decompression circuit.

17. The charging device according to claim 15, wherein the first side wall of said conductive film is provided with a protrusion protruding outward, and the side wall of said corona grid is provided with a through-hole corresponding to said protrusion.

18. A photosensitive drum component, comprising:
a lower frame, wherein a photosensitive drum is installed inside said lower frame;
an upper frame being installed on the lower frame; and
a charging device being installed inside the upper frame,
wherein said charging device comprises a corona grid and a fur brush, said corona grid has a side wall and a lower wall adjacent to said side wall, and said lower wall is provided with a plurality of grids, and a corona wire being located above the lower wall of said corona grid,
wherein a decompression module is provided between said corona grid and said fur brush, one end of said decompression module being connected with said corona grid, and the other end of said decompression module being connected with said fur brush.

19. The photosensitive drum component according to claim 18, wherein said decompression module has a conductive film and a decompression device connected with said conductive film in series.

20. The photosensitive drum component according to claim 19, wherein said decompression device comprises one of a resistor and a decompression circuit.

21. The photosensitive drum component according to claim 19, wherein a first side wall of said conductive film is provided with a protrusion protruding outward, and the side wall of said corona grid is provided with a through-hole corresponding to said protrusion.

22. The photosensitive drum component according to claim 19, wherein said conductive film has a first side wall docked to the side wall of said corona grid, and a second side wall connected with said side wall through a connection wall, and wherein said second side wall is connected with said fur brush through said decompression device.

23. The photosensitive drum component according to claim 22, wherein said decompression device comprises one of a resistor and a decompression circuit.

24. The photosensitive drum component according to claim 22, wherein a first side wall of said conductive film is provided with a protrusion protruding outward, and the side wall of said corona grid is provided with a through-hole corresponding to said protrusion.
